(19) United States
(12) Patent Application Publication
(10) Pub. No.: US 2016/0376172 A1
(43) Pub. Date: Dec. 29, 2016

(54) PORTABLE ELECTRONIC WATER DISINFECTION DEVICE WITH REPLACEABLE TREATMENT CARTRIDGES

(71) Applicant: John Frederick Ellers, Victor Harbox (AU)

(72) Inventor: John Frederick Ellers, Victor Harbox (AU)

(21) Appl. No.: 13/660,984

(22) Filed: Oct. 25, 2012

(51) Int. Cl. C02F 1/463

(52) U.S. Cl. CPC C02F 1/463

(57) ABSTRACT

A portable batch water storage and treatment unit includes a unit housing divided by internal partitions into a hardware chamber containing a water pump, an electronic control panel, a unit electric circuit, and an electric power source; an electrocoagulation chamber retaining a replaceable electrocoagulation cartridge containing plates electrically connected to the battery by the unit circuit through the control panel; a filter chamber in fluid communication with the electrocoagulation chamber and retaining a water filter cartridge; and a clean water reservoir chamber in fluid communication with the filter chamber for receiving and holding water pumped through the electrocoagulation and filter chambers; and a water inlet and outlet ports in the unit housing.

This application continues from provisional patent application Ser. No. 61/628,340, filed on Oct. 28, 2011.

### BACKGROUND OF THE INVENTION

1. Field of the Invention

The present invention relates generally to the field of water treatment devices and systems. More specifically the present invention relates to a portable batch water storage and treatment unit sized to be hand carried which, like a conventional canteen, cm or water but unlike a canteen cm additionally treat and purify water from almost any available source through filtration and, where necessary, through electrocoagulation to replace consumed stored water. The unit can be manufactured in larger or smaller overall sizes, depending on the specific needs of a particular group of end users. The unit includes a unit housing divided by sealed internal housing partitions into a hardware chamber containing a water pump, an electronic control panel, a unit electric circuit having circuit wiring, and a power jack extending through the unit housing to be accessible from outside the unit preferably to recharge a battery contained within the hardware chamber and alternatively or additionally to connect to a power cord for extending to an external power source to deliver power to the unit circuit; an electrocoagulation chamber retaining a spaced series of parallel electrocoagulation plates electrically connected to the battery or external power source by the unit circuit wiring through the control panel; a filter chamber in fluid communication with the electrocoagulation chamber and retaining a water filter; and a clean water reservoir chamber in fluid communication with the filter chamber for receiving and holding water pumped through the electrocoagulation chamber and the filter chamber; and a water inlet port with an inlet lid in the top of the unit housing opening into the electrocoagulation chamber and a water outlet port also in the top of the unit housing having an outlet lid and opening out of the reservoir chamber for dispensing drinkable water.

A key inventive feature of the present unit is the provision of plates in a removable electrocoagulation cartridge. The electrocoagulation cartridge includes a plate mounting case preferably in the form of a square tube with closed ends and having an electrocoagulation cartridge inlet opening in the plate mounting case at the electrocoagulation cartridge upper end and an electrocoagulation cartridge outlet opening in the plate mounting case at the electrocoagulation cartridge lower end, containing and mounting the spaced series of parallel electrocoagulation plates, and having outwardly protruding cast metal strips in the plate mounting case lower end to make electrical connection between the power source and the plates. The electrocoagulation cartridge is periodically removed from the unit and replaced as the plates are consumed through repeated operation of the electrocoagulation feature. The filter preferably is provided as part of a filter cartridge as well, including a filter mounting case.

2. Description of the Prior Art

There have long been water treatment systems and units for disinfecting contaminated water to make the water potable such as through the process of electrocoagulation. In general principle, as described generally WIKIPEDIA.COM™, electrocoagulation water treatment consists of passing contaminated water through a unit containing an electrolytic cell with an anode connected to a power source and a cathode spaced apart from the anode. The anode electrochemically corrodes as a result of oxidation. The anode and cathode in many instances are pairs of conductive plates such as of iron which function as sacrificial electrodes. The anode releases ions which neutralize the charges of suspended contaminant particles so that they clump together, or coagulate, and so that they float to the surface and thus are readily removed from the water. In addition, this process alters the physical and chemical properties of the contaminants through reactions including oxidation reduction, emulsion breaking, seeding, halogen complexing, bleaching, and significant neutralization of any acidic or basic characteristic. As a result, heavily contaminated water can be purified to such an extent as to be safe for human consumption.

A problem with prior systems and onus has been that replacement of electrocoagulation elements such as plates necessarily consumed during normal electrocoagulation operation has been time consuming and often difficult. Another problem is that a water treatment unit suitable in size and other features to be carried as a replenishable canteen is not disclosed in the art.

It is thus an object of the present invention to provide a portable electronic water disinfection unit.

It is another object of the present invention to provide such a unit which includes electrocoagulation means, preferably in the form of a removable and replaceable electrocoagulation cartridge containing at least the electrocoagulation elements preferably in the form of spaced and parallel plates, so that spent and depleted plates can be replaced easily and all at once by replacing the electrocoagulation cartridge within the unit.

It is still another object of the present invention to provide such an unit which includes water filtering means, preferably in the form of a removable and replaceable filter cartridge, once again so that when the filter within the filter cartridge has gathered enough contaminants from flowing water to restrict flow to an unacceptable extent, the filter can be replaced easily by replacing the filter cartridge within the unit.

It is finally an object of the present invention to provide such a unit which is very well suited to production in a highly compact, portable size and convenient shape for manual gripping, such as for use as a canteen with water treatment capability, and which is efficient, easy to use, safe and very reliable.

### SUMMARY OF THE INVENTION

The present invention accomplishes the above-stated objectives, as well as others, as may be determined by a fair reading and interpretation of the entire specification.

The present water storage and treatment unit can disinfect water, as previously noted, through the process of filtration, and where necessary through electrocoagulation. The unit is a portable batch unit including an electronic control system, an electrocoagulation chamber containing a replaceable electrocoagulation cartridge, a filter chamber containing a replaceable filter cartridge, a water pump and a water storage reservoir chamber. The unit can also be used as a standard canteen for the carrying of potable water. A batch of water is poured through an inlet port into the electrocoagulation chamber and cartridge, and the electrocoagulation function is activated if necessary to perform an initial disinfection of the batch of water, and the water is then pumped through the filter cartridge within the filter chamber from which the then purified and potable water flows into the reservoir chamber, from which it can be decanted through the outlet port for consumption as needed.

### BRIEF DESCRIPTION OF THE DRAWINGS

Various other objects, advantages, and features of the invention will become apparent to those skilled in the art from the following discussion taken in conjunction with the following drawings, in which

FIG. 1 is a lower perspective view of a preferred embodiment of the unit, with the filter cartridge and electrocoagulation cartridge shown withdrawn from and in exploded relation to the unit.

FIG. 2 is an upper perspective view of the unit of FIG. 1.

FIG. 3 is a cross-sectional front view of the unit of FIG. 1, with the exception of the portion of the front of the unit mounting the control panel, showing the electrocoagulation chamber, cartridge and plates, the filter chamber, cartridge and filter, and the reservoir chamber, with the internal housing partitions shown in broken lines.

FIG. 4 is top view of the unit of FIG. 3, with the battery, and the internal housing partitions defining the electrocoagulation compartment, filter compartment and reservoir compartment shown in broken lines.

FIG. 5 is bottom view of the unit of FIG. 3, with the battery shown in broken lines.

FIG. 6 is cross-sectional right end view of the unit of FIG. 3.

FIG. 7 is a cross-sectional rear view of the unit of FIG. 3.

FIG. 8 is a cross-sectional side view of the electrocoagulation cartridge revealing the plates.

FIG. 9 is a cross-sectional side view of the filter cartridge revealing the filter.

FIG. 10 is a side view of the preferred rotatable locking assembly showing the opposing retracting locking tabs and the central gripping bar.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### First Preferred Embodiment

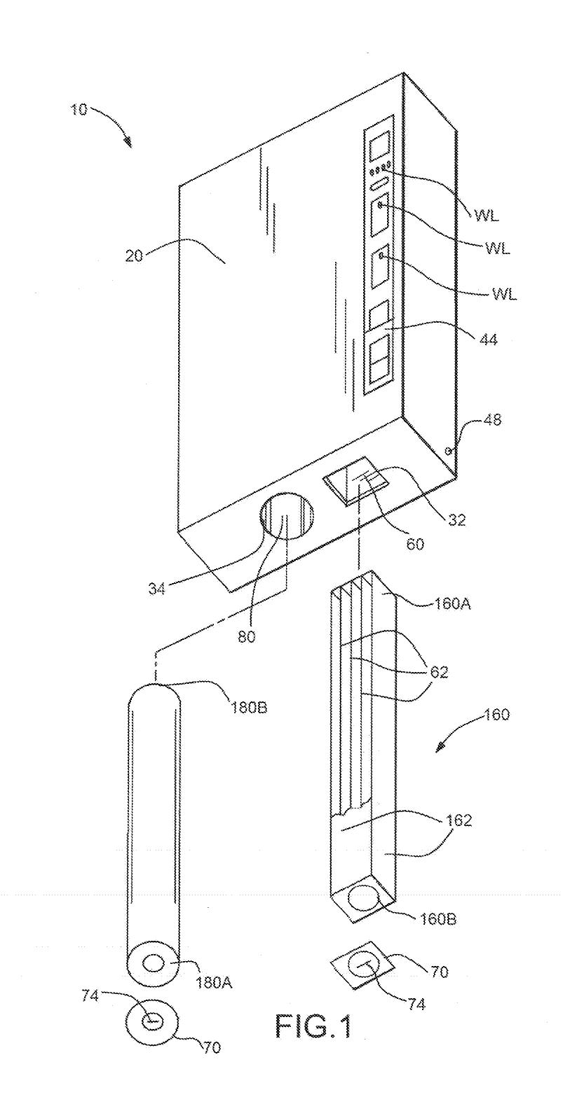

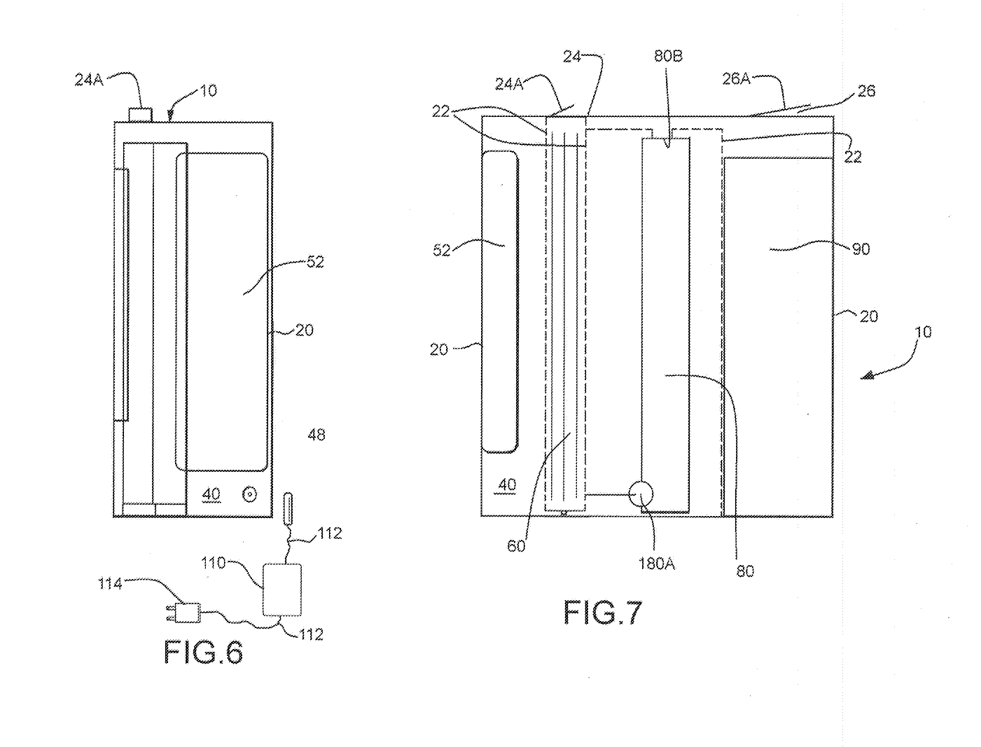

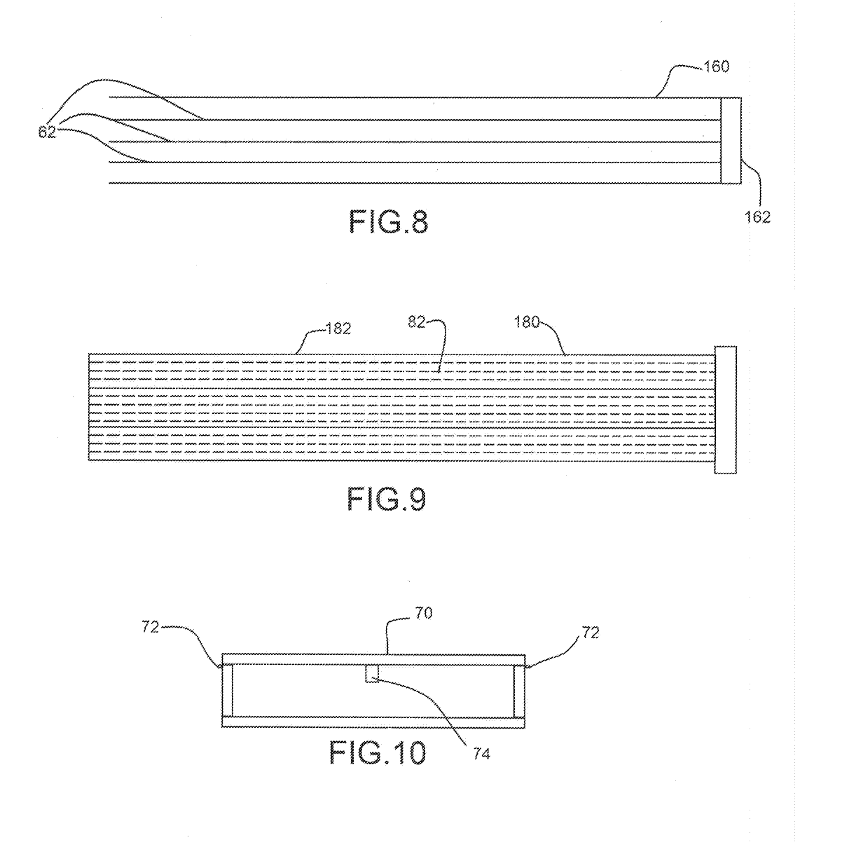

Referring to FIGS. 1-10, a portable batch water storage and treatment unit 10 is disclosed which can both store and disinfect and otherwise purify water. Unit 10 can be manufactured in larger or smaller overall sizes, depending on the specific needs of a particular group of end users. An embodiment of unit 10 sized to be a medium or large non-portable device is further contemplated.

The unit 10 includes a unit housing 20 divided by sealed internal housing partitions 22 into a hardware chamber 40 containing a water pump 42, an electronic control panel 44, a unit electric circuit having circuit wiring 46, and a power jack 48 extending through the unit housing 20 to be accessible from outside the unit 10 preferably to recharge a unit battery 52 contained within the hardware chamber 40 and alternatively or additionally to a power cord (not shown) extending to an external power source such as a wall outlet to deliver power to the unit circuit; an electrocoagulation chamber 60 retaining a spaced series of parallel electrocoagulation plates 62 electrically connected to the unit battery by the unit circuit wiring 46 through the control panel 44; a filter chamber 80 in fluid communication with the electrocoagulation chamber 60 and retaining a water filter 82; and a clean water reservoir chamber 90 in fluid communication with the filter chamber 80 for receiving and holding water pumped through the electrocoagulation chamber 60 and the filter chamber 80; and a water inlet port 24 with an inlet lid 24A in the top of the unit housing 20 opening into the electrocoagulation chamber 60 and a water outlet port 26 also in the top of the unit housing 20 having an outlet lid 26A and opening out of the reservoir chamber 90 for dispensing drinkable/potable water. The inlet lid 24A and the outlet lid 26A preferably each include mechanisms (not shown) which release excess pressure from within the unit 10 such as that resulting from atmospheric or other external heat or from de-pressurization at high altitude, and the lids 24A and 26A may be of different sizes and marked such as through color coding to alert a user against drinking from the inlet port 24. An AC-to-DC charger 110, similar to those used with laptop computers, with as power cord 112 such as for plugging into a wall outlet or into an automobile power socket/adaptor and a plug 114 for engaging the power jack 48.

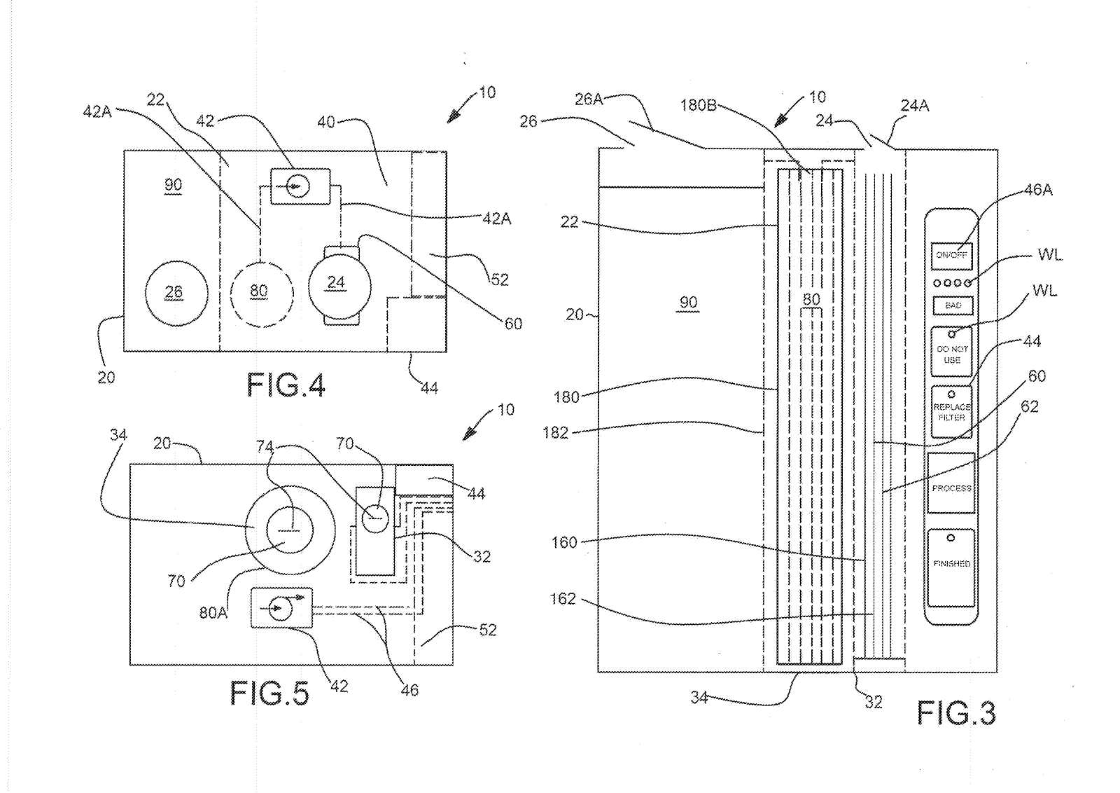

A key inventive feature of the present unit is the provision of plates 62 in a removable electrocoagulation cartridge 160 form. The electrocoagulation cartridge 160 preferably includes a plate mounting case 162, preferably in the form of a square tube with closed ends and having an electrocoagulation cartridge inlet opening 160A in the plate mounting case 162 at the electrocoagulation cartridge 160 upper end and a electrocoagulation cartridge outlet opening 160B in the plate mounting case 162 at the electrocoagulation cartridge 160 lower end registering with and in fluid communication with an electrocoagulation chamber outlet opening 60B at the electrocoagulation chamber 60 lower end. See FIGS. 3 and 4. Electrocoagulation cartridge 160 contains and mounts the spaced series of parallel electrocoagulation plates 62, and having outwardly protruding cast metal strips (not shown) in the plate mounting case 162 lower end for electrical connection to the unit circuit 46. The electrocoagulation cartridge 160 is periodically removed from the unit 10 and replaced as the plates 62 are consumed through repeated operation of the electrocoagulation feature. The filter 82 preferably is provided as part of a filter cartridge 180 as well, the filter cartridge 180 including a filter mounting case 182 preferably in the form of a circular tube with closed end walls and having a filter cartridge inlet opening 180A in the filter mounting case 182 registering with and in fluid communication with the filter chamber inlet opening 80A and located at the filter cartridge 180 lower end and also in fluid communication with the electrocoagulation cartridge outlet opening 160B through as pumping tube 42A into which the pump 42 is operationally mounted, and a filter cartridge outlet opening 180B in the filter cartridge 180 upper end, and containing water filtering material such as a filter sheet having an accordion configuration to maximize sheet surface area. See FIGS. 3 and 4. The electrocoagulation and filter cartridges 160 and 180 preferably are each passed into and out of their respective chambers 60 and 80 through corresponding electrocoagulation cartridge and filter cartridge ports 32 and 34 in the bottom of the unit housing 20, and are each releasibly locked into mounted position within their respective chambers 60 and 80 by a rotatable locking assembly 70 with retracting locking tabs 72 which engage the unit housing 20, and which may be of conventional latch design, and a central gripping bar 74 of assembly 70 permitting human finger gripping for assembly 70 rotation. See FIGS. 5 and 10.

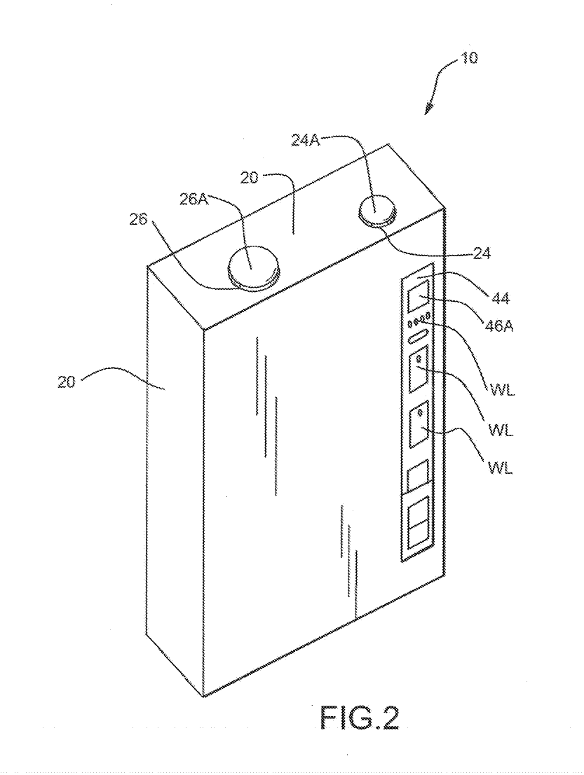

The control panel 44 preferably includes not only pump and power switches 46A (see FIGS. 2 and 3) controlling electric current flow respectively between the pump 42 and battery 52 or external power source and between the electrocoagulation plates 62 and battery 52 or external power source, but preferably additionally includes a waste water testing mechanism (not shown) of conventional design with sensors (not shown) extending into the electrocoagulation chamber 60 to determine the type and duration of treatment needed to make the particular water batch safe to drink. In some instances the water may only require filtration, and in this instance the pump 42 is activated to deliver water through the filter chamber 80 and into the reservoir chamber 90 without delivering electric current to the plates 62, and thus without activating the electrocoagulation function. In other instances, where the water has a higher concentration of impurities or has impurities of certain types, the waste water testing mechanism determines the need to activate the electrocoagulation function for a certain length of time before pumping the water batch out of the electrocoagulation chamber 60 and through the filter chamber 80. The control panel 44 preferably includes warning lights WL for alerting the user to low battery 52 charge, unusable water or a blocked filter, and in addition to warning lights WL the unit 10 may include an audible unit warning alarm triggered simultaneously with the particular warning lights.

The housing 20 and lids 24A and 26A may be constructed from any suitable plastic, carbon fiber composite or from metal, or a combination of these materials. The selected construction materials preferably are entirely recyclable. The housing 20 may be a rubberized casing such as of the material commonly used to make cellular telephone covers. The unit 10 preferably is constructed to be water resistant to a depth of at least one meter. The unit 10 is optionally incorporated into a customized backpack (not shown). The unit 10 preferably is pre-filled with drinkable water at a camp or other base before being carried on an excursion away from conventional clean water sources, such as into the open countryside.

While the invention has been described, disclosed, illustrated and shown in various terms or certain embodiments or modifications which it has assumed in practice, the scope of the invention ms not intended to be, nor should it be deemed to be, limited thereby and such other modifications or embodiments as may be suggested by the teachings herein are particularly reserved especially as they fall within the breadth and scope of the claims here appended.

1. (canceled)

2. (canceled)

3. (canceled)

4. (canceled)

5. (canceled)

6. (canceled)

7. (canceled)

8. (canceled)

9. (canceled)

10. (canceled)

11. A water treatment unit, comprising:
a unit housing comprising an electrocoagulation chamber;
a replaceable electrocoagulation cartridge removably retained within said electrocoagulation chamber and containing a plurality of electrically conductive electrocoagulation plates;
unit control means;
a unit electric circuit electrically connected to said unit control means and adapted to be electrically connected to an electric power source, wherein the unit electric circuit includes metal strips configured to electrically connect at least one of said plates to said power source, wherein the at least one of said plates electrically connects to said power source through said unit control means, and wherein said metal strips protrude into the electrocoagulation chamber to electrically connect the at least one of said plates when said replaceable electrocoagulation cartridge is retained within said electrocoagulation chamber; and
a water inlet port in said unit housing and a water outlet port in said unit housing in fluid communication with said electrocoagulation chamber.

12. The unit of claim 11, wherein said electrocoagulation cartridge includes a plate mounting case, wherein said plate mounting case includes a first side wall opposite to a second side wall, and an upper end wall opposite to a lower end wall, wherein the upper and lower end walls extend between the first and second side walls, and wherein said plate mounting case is configured to contain and mount said plates between said first and second side walls.

13. The unit of claim 12, wherein said plate mounting case lower end wall defines an opening for passage of water.

14. The unit of claim 12, wherein said plate mounting case mounts said plates in a substantially mutually parallel configuration.

15. The unit of claim 12, wherein said plate mounting case is in the form of a square tube.

16. The unit of claim 12, wherein said unit electric circuit metal strips are located at the plate mounting case lower end wall.

17. The unit of claim 11, wherein said unit electric circuit metal strips are configured to electrically connect the at least one of said plates to said power source within the water being treated.

18. The unit of claim 11, wherein said plates is configured to be entirely located within the water being treated.

19. The unit of claim 11, wherein said unit is a portable unit.

20. The unit of claim 11, wherein the unit is a portable batch water storage and treatment unit.

21. The unit of claim 11, wherein said unit control means comprises a unit control panel mounted to said housing.

22. The unit of claim 11, further including said power source.

23. The unit of claim 11, further including a water pump electrically connected to said unit electric circuit and in fluid communication with said electrocoagulation chamber.

24. The unit of claim 23, wherein the unit includes a clean water reservoir chamber in fluid communication with said water pump and said electrocoagulation chamber for receiving and holding water pumped through said electrocoagulation chamber.

25. The unit of claim 24, wherein the unit further includes a filter chamber in fluid communication with said electrocoagulation chamber and said clean water reservoir chamber, and a replaceable water filter cartridge removably retained within said filter chamber.

26. The unit of claim 25, wherein the unit housing is divided by sealed internal housing partitions to provide: a hardware chamber including said water pump and said unit control means, said electrocoagulation chamber, said clean water reservoir chamber and said filter chamber; wherein said water inlet port in said unit housing opens into said electrocoagulation chamber, and wherein said water outlet port opens out of the clean water reservoir chamber.

27. The unit of claim 26, wherein the unit further includes a power source, and wherein said power source includes a battery located in said hardware chamber.
